(19) United States
(12) Patent Application Publication
(10) Pub. No.: US 2003/0164958 A1
(43) Pub. Date: Sep. 4, 2003

(54) Image forming apparatus using heating sublimation technique

(76) Inventors: Kazunobu Shima, Wakayama-shi (JP); Hidetoshi Nishikawa, Wakayama-shi (JP); Masazumi Ishikawa, Wakayama-shi (JP)

Correspondence Address: FULBRIGHT & JAWORSKI, LLP, 666 FIFTH AVE, NEW YORK, NY, 10103-3198, US

(21) Appl. No.: 10/365,329

(22) Filed: Feb. 12, 2003

(30) Foreign Application Priority Data
Feb. 14, 2002 (JP) PAT. 2002-36979
Jun. 11, 2002 (JP) PAT. 2002-169789
Apr. 3, 2002 (JP) PAT. 2002-100888
Apr. 3, 2002 (JP) PAT. 2002-100890

(51) Int. Cl. G06F 15/00; B41J 1/00

(52) U.S. Cl. 358/1.7

(57) ABSTRACT

An image forming apparatus includes a print head (2) controllably driven according to print data; a heater device (HU) for applying thermal energy to a recording medium (1) in order to fix ink applied on its surface layer by the print head onto its fixing layer (11); and a controller (7) for producing the print data from image data. The controller (7) includes a deformation compensating section (9) for compensating for displacement between a target image and a fixed image due to size change in the vertical and/or lateral direction of the recording medium occurring in association with application of the thermal energy thereto. The controller (7) includes also a fixing color development characteristics compensating section (92) for effecting fixing color development characteristics compensation during the production of the print data from the image data, based on fixing color development characteristics of the ink to the fixing layer dependent on the thermal energy and a heat absorption rate compensating section (96) for compensating for a difference in a color-dependent heat absorption rate for a radiant heat beam during the production of the print data from the image data.

### BACKGROUND OF THE INVENTION

1. Field of the Invention

The present invention relates to an image forming apparatus implementing heating sublimation technique, comprising a print head controllably driven according to print data and a heater device for applying thermal energy to a recording medium in order to fix ink applied on its surface layer by the print head onto its fixing layer.

2. Description of the Related Art

An exemplary conventional technique relating to the above field of art is disclosed in Japanese patent application “Kokai” No: Hei. 10-297197. According to this, a metal substrate includes a coloring ground layer acting also as a rust-preventive layer, a transparent resin layer as an optical transparent resin layer formed over the coloring ground layer, the resin layer being made of acrylic resin, polyester resin, urethane resin etc., and an inkjet receiving layer formed over the resin layer and made of e.g. porous alumina. After application of a sublimating ink or pigment on the inkjet receiving layer by an inkjet printing, the sublimating pigment is heated in a heating furnace or by a hot press, whereby the sublimating pigment in the inkjet receiving layer is sublimed into the transparent resin layer. Then, the inkjet receiving layer is removed to obtain an ornamental metal body having a colored pattern fixedly formed within the transparent resin layer.

According to further art disclosed by Japanese patent application “Kokai” No: 2001-105638, sublimating ink is transferred from an ink ribbon onto a surface of a recording sheet. In order to heat and fix the ink on the sheet, the sheet is charged into a heater box, in which the sheet is advanced and heated between a press roll and a heat roll opposed to each other with a small gap therebetween or between a heat roll and a conveyer belt disposed along a portion of the peripheral face of the heat roll, and then the sheet is discharged from the heater box immediately.

Further, in the field of textile printing, according to an exemplary technique disclosed by Japanese patent application “Kokai” No: Hei. 08-311782, dye is applied to a textile by the inkjet printing method. Then, in order to reinforce the fixing of the dye and also to improve its color development, the textile is charged into a heater device to be heated therein. Then, the textile is discharged from the device immediately to be cooled at the room temperature.

Still further, Japanese patent application “Kokai” No: Hei. 10-16188 discloses an image forming apparatus. According to this, first, a primary image is formed on a thermal transfer sheet by e.g. an inkjet printer. Then, this thermal transfer sheet having the image formed thereon is laid over a recording sheet and these sheets are pressed and heated together, whereby the image (ink) formed on the thermal transfer sheet will be sublimed by the heat and transferred onto an ink fixing layer of the recording sheet, thus forming a secondary image thereon. With this, a finished printed product is obtained.

Another image forming apparatus is known from Japanese patent application “Kokai” No: Hei. 10-230589. According to this, a laminated material layer is provided in advance on an ink fixing layer of a recording sheet. Then, an image is formed on the laminated material layer by e.g. an inkjet printer. Then, the resultant sheet is pressed and heated by heat rolls, thereby to make the laminated material layer transparent and also to fix the ink pigment on the fixing layer. With this, a finished printed product is obtained.

All of the techniques described above subject the recording medium (sheet) to thermal load. However, the conventional image forming apparatuses have failed to provide any measures or solutions to cope with the thermal load applied to the recording medium.

One of the disadvantageous effects of thermal load on image formation is associated occurrence of thermal contraction or expansion which can lead to inadvertent change in the dimensions in the finished recording medium. First of all, such size change leads to a difference between dimensions of a target image which dimensions were calculated in advance when corresponding image data were produced and dimensions of the image actually obtained on the finished printed product. If the printed product is to be used in combination with another printed product or object, such difference, even if a small difference, can lead to an unsightly conspicuous, i.e. non-negligible, displacement in the registry between the products or sheets (e.g. displacement in the positions of the register marks), especially, in the case of a large printed product.

Another problem or difficulty arising from the application of thermal load to the recording medium is change in fixing color development characteristics of the ink to the fixing layer due to various factors.

In an attempt to obtain more uniform temperature distribution than possible when using heat rolls, the prior art has also proposed to employ, as the heater device, a heat beam generating mechanism for generating radiant beam of infrared or near-infrared beam so as to apply the heat to the recording medium in a more moderate and uniform manner not momentarily but over an extended period of time. However, this method suffers another problem. Namely, the primary color components for together forming a color image have different heat absorption rates (optical absorption coefficients) from each other. Hence, if radiant heat beam of infrared or near-infrared beam is employed, ink of a certain color exhibits greater resistance to absorption of that heat beam (though depending on the spectrum distribution of the radiant beam employed, in general, yellow is said to have poorer heat absorption than cyan or magenta). In other words, such radiant heat beam exhibit heat absorption characteristics differing for respective ink colors. As a result, fixing process tends to be insufficient for the ink of such color which has absorbed less radiant heat than the inks of the other colors, thus resulting in poorer color development and/or color irregularity relative to the other colors.

### SUMMARY OF THE INVENTION

In view of the above-described state of the art, a primary object of the present invention is to provide an image forming apparatus capable of solving the above-described drawbacks of the prior art and providing quality printed products without relying on any costly heater device equipped with sophisticated control functions.

For accomplishing the above object, according to one aspect of the present invention, there is proposed an image forming apparatus comprising: a print head controllably driven according to print data; a heater device for applying thermal energy to a recording medium in order to fix ink applied on its surface layer by the print head onto its fixing layer; and a controller for producing the print data from image data; wherein the controller includes a deformation compensating section for compensating for displacement between a target image and a fixed image due to size change in the vertical and/or lateral direction of the recording medium occurring in association with application of the thermal energy thereto.

With the above construction, the apparatus has been newly provided with the deformation compensating section for compensating for the displacement phenomenon, addressed by the present inventor, occurring between a target image and a fixed image due to size change in the vertical and/or lateral direction of the recording medium associated with application of the thermal energy thereto. With this feature, the apparatus is capable of providing an improved fixed image which is substantially identical to or at least only negligibly different from the target image even if the recording medium has changed in its size after the image formation from its original size state before the same.

Of such displacements between a target image and a fixed image, the most important type of displacement in terms of its effect on the quality of the printed product is an image size displacement. In view of this, the deformation compensating section preferably provides a function for compensating for an image size displacement. Specifically, this function for compensating for an image size displacement can be realized by appropriate pre-adjustment of the image data. For instance, if the thermal load causes 2% contraction in the vertical direction and 1% contraction in the lateral direction in the fixed image relative to the target image due to associated size change in the recording medium; then, an image enlarging operation may be effected in advance on its source image data for “enlarging” the data in the vertical and lateral directions in order to compensate for the such expected respective contraction amounts. Conversely, if the thermal load causes expansion in the recording medium, the image data may be subjected to a reducing adjustment. For a re-sampling operation needed in such enlarging or reducing process of the image data, an appropriate interpolation operation may be effected to suit each image.

In any case, the size change in the vertical and/or lateral direction of the recording medium may vary significantly, depending on the type (material) of the recording medium and the amount of the thermal energy applied thereto. In order to readily cope with this problem, according to one preferred embodiment of the invention, said deformation compensating section stores therein a table of compensation adjustment data which were calculated in advance for respective various possible conditions, so that the deformation compensating section may extract appropriate compensation data from this table based on the type of recording material employed and the thermal energy (heating temperature and/or heating period) to be applied thereto and may use this data for the deformation compensation.

In case the size change in the vertical and/or lateral direction of the recording medium occurs by a non-negligible degree due to e.g. daily change in the environmental conditions, it will be needed for each image forming apparatus installed to effect its own “on- site” measurement of such size change expected for the recording medium to be employed. Hence, in order to readily allow for such measurement, according to one preferred embodiment of the invention, there are provided test print data used for obtaining size change in the vertical and/or lateral direction of the recording medium. With this construction, on the recording medium to be used and, prior to the actual printing operation there will be formed an image of test pattern suitable for determining the size change in the recording medium. Accordingly, the construction facilitates production of the adjustment data used for compensating for size change in the recording medium due to thermal load application, consequently, for displacement between a target image and a fixed image due to such size change.

Further, if the apparatus implements the inkjet printing technique which represents color densities in terms of area gradations, color density displacement will be important among various possible displacements between a target image and a fixed image. For this reason, it will be advantageous for the deformation compensating section to provide a further function of compensating for such image density displacement. More particularly, the image density displacement is believed to be attributable to relative increase in the pigment amount per unit area associated with thermal contraction in the recording medium or relative decrease thereof associated with thermal expansion in the medium. Whatever the real cause, adjustment should be made for each particular color component (R, G, B or C, M, Y) for reducing in advance the density of image data in the case of the density increasing tendency in the fixed image or for increasing it in advance in the case of the density decreasing tendency therein. And, it will be advantageous if the compensation adjustment table and/ or the test pattern data includes also such data suitable to cope with the color density change.

Moreover, in order to readily allow compensation for a change in fixing color development characteristics during the heating process, said controller of the invention's image forming apparatus further includes a fixing color development characteristics compensating section for effecting fixing color development characteristics compensation in the course of the production of the print data from the image data, based on the fixing color development characteristics of the ink relative to the fixing layer of the recording medium obtained through the heating of the recording medium.

In the case of the above construction, any failure to finally obtain appropriate fixing color development characteristics is not attributed to or improvement therefor is not sought in the original characteristics of the recording medium to be employed and/or the specification of the heating device. Rather, if a particular condition causes change in the density value of a print dot formed on the recording medium with an ink droplet from the print head such as an inkjet print head, such change is estimated in advance and adjustment is made for increasing the density value of the source image data in advance so that the density of the resultant print dot will be appropriate. If shortage in the density of the print dot (an example of change or deviation from the proper value of the fixing color development characteristics) occurs due to the particular characteristics of the recording medium employed and/or to the specification of the heater device, then, adjustment will be made for increasing in advance the density value of the image data, so that the density of the resultant print dot will be appropriate (appropriate fixing color development characteristics). The amounts of adjustment to be used for such fixing color development compensation may be obtained experimentally. It will be advantageous if a variety of adjustment tables are prepared based on the experiments and one of them is selected for each actual printing operation to be effected.

According to one preferred mode of the fixing color development characteristics compensating section, the section adjusts the image data with taking into consideration fixing color development characteristics of the recording medium whose type has been identified by a recording medium type identifying section. In this case, fixing color development characteristics of various types of recording media usable by the image forming apparatus will be obtained in advance through experiments for the respective types. And, adjustment amounts for approximating these fixing color development characteristics to the corresponding respective optimal characteristics will be prepared in the form of a plurality of tables for selective use. This construction will advantageously eliminate troubles of changing the heating temperature and/or heating period in loading each particular recording medium of different fixing color development characteristics.

According to another preferred mode of the fixing color development characteristics compensating section, an environment temperature detecting section is provided for detecting an environment temperature of the image forming apparatus; and the fixing color development characteristics compensating section provides a further function of adjusting the image data with taking into consideration change in the fixing color development characteristics due to the environment temperature detected by the environment temperature detecting section. In this case too, for the purpose of testing, the image forming apparatus will be installed for a variety of environmental temperature conditions in order to experimentally obtain fixing color development characteristics associated with the respective environment temperature conditions. Then, adjustment amounts for approximating these fixing color development characteristics to the corresponding respective optimal characteristics will be prepared in the form of a plurality of tables for selective use. This construction will make it possible to obtain predetermined constant fixing color development characteristics at all hours of the day or in all seasons, without requiring such costly solutions of providing a heat insulating treatment to the principal portion of the image forming apparatus or providing even an air conditioner.

According to still another preferred mode of the fixing color development characteristics compensating section, the image data are adjusted with taking into consideration change in the fixing color development characteristics associated with heating and/or drying irregularity during the heating process of the recording medium. With a standard heater device, especially with the type of heater device for applying heat to the recording medium by supplying hot air current thereto, the device fails to provide uniform two-dimensional distribution of temperature or dryness conditions. This leads to heating and/or drying irregularity on the recording medium inherent from the image forming apparatus, and such irregularity will invite some regional deterioration in the fixing color development characteristics. Then, in order to approximate such locally deteriorated fixing color development characteristics to the ideal fixing color development characteristics, adjustment amounts used therefor will be prepared in the form of a plurality of tables for selective use. With this, the heater device and/ other component associated therewith need not satisfy unrealistically high performance requirements.

When a certain type of sublimating type ink suitable for use in the invention's image forming apparatus is heated and sublimed to be fixed and color-developed in the fixing layer of the recording medium, if the print dots together constituting a printed image are distributed with a density above a certain predetermined level, a desired density may not be obtained, partly due to a relatively large amount of heat required for the sublimation of the ink. In such case, it will be possible to calculate or estimate in advance a fixing color development deficient area, e.g. an area deficient in the density, of print dots constituting a final printed image to be obtained from the image date as a print source. In order to cope with this, adjustment amounts of the image data required for approximating the fixing color development characteristics of such area where deficiency of fixing color development is anticipated to appropriate fixing color development characteristics will be prepared in the form a table for selective use. This construction may be very advantageous in certain uses of the apparatus.

According to still further preferred embodiment of the invention, the apparatus further comprises a mode selecting section for selectively providing a fixing color development compensating mode for effecting the above-described image data adjustment by the fixing color development characteristics compensating section and a fixing color development non-compensating mode for not effecting said image data adjustment by the fixing color development characteristics compensating section. With this feature, the image forming apparatus will obtain further improved utility.

Further, in order to avoid color irregularity which tends to occur when the heater section employs a radiant heat beam exhibiting differing heat absorption properties for the respective ink colors, preferably, in the image forming apparatus of the invention, said controller for producing the print data from image data includes also a heat absorption rate compensating section for compensating for a difference in the color-dependent heat absorption rate of the radiant heat beam in the course of the production of the print data from the image data.

With this feature, image date corresponding to a color having a different heat absorption rate relative to the other color, that is, a density value of a particular color component is adjusted, so that the color irregularity associated with irregularity in fixing color development condition due to the heat absorption rates differing for the respective color components may be compensated for in advance at the stage of source image data.

The adjustment ratio (adjustment amount) for such heat absorption rate compensation may be prepared from actual measurement data obtained through experiments or may be calculated based on the spectrum data of each color component of the ink and the spectrum data of the radiant heat beam employed. In either case, the adjustment amount thus obtained will be stored as an adjustment coefficient in a re-writable heat absorption rate compensation lookup stable. Preferably, this heat absorption rate compensating lookup table is prepared not in one kind, but in a plurality of kinds for possible variation of ink, variation of the radiant heat beam as well as for the respective stages of time changes thereof.

As one example of such heat absorption rate compensating section, if a certain particular color component (one of the primary print color components) has a lower heat absorption rate for the radiant heat beam than the other color components, it is proposed to increase the density value of this particular color component in the image data. As another example of the heat absorption rate compensating section, if a certain particular color component has a higher heat absorption rate for the radiant heat beam than the other color components, thus resulting in a high density in the final stage, it is proposed to decrease the density value of this particular color component in the image data. The selection between these two methods of heat absorption rate compensation may be made based on relationship between image data under consideration with a dynamic range for each image data under consideration.

According to a still further preferred embodiment of the invention, the apparatus further comprises a mode selecting section for selectively providing a heat absorption rate compensating mode for effecting the above-described heat absorption rate compensation by the heat absorption compensating section and a heat absorption rate non-compensating mode for not effecting said heat absorption rate compensation by the heat absorption rate compensating section. Namely, if the image to be printed comprises a monotone image to be printed with black ink only or the recording medium selected for use comprises a type of medium not requiring any heating fixation at all, the heat absorption rate compensation will be less useful or useless at all. Hence, with the provision of the above-described mode selecting function between the heat absorption rate compensating mode and the heat absorption rate non-compensating mode, the utility of the image forming apparatus will be even further improved.

If needed, the controller of the image forming apparatus of the invention may includes all or any combination of the above-described various compensating sections, i.e. the deformation compensating section, fixing color development characteristics compensating section and the heat absorption rate compensating section.

Further other features and advantages of the invention will become apparent upon reading the following detailed description of preferred embodiments thereof with reference to the accompanying drawings.

### BRIEF DESCRIPTION OF THE DRAWINGS

FIG. 1 is a section view showing an example of recording medium to be processed by an image forming apparatus relating to the present invention,

FIG. 2 is an appearance view of an image forming apparatus according to one preferred embodiment of the invention,

FIG. 3 is a schematic section showing a construction of a printing station of the image forming apparatus,

FIG. 4 is a schematic section showing a construction of a printing unit included in the printing station,

FIG. 5 is an explanatory view illustrating relationship between a target image and a fixed image in an image forming operation using a heat-contractible recording medium,

FIG. 6 is a functional block diagram illustrating various functions of a controller,

FIG. 7 is a flowchart illustrating a process until an image is formed on a recording medium based on inputted image data under a deformation control scheme,

FIG. 8 shows a monitor display showing a deformation compensation data input screen,

FIG. 9 is a further monitor display showing a deformation data input screen relating to the second embodiment of the invention,

FIG. 10 is a functional block diagram illustrating various functions of a controller relating to the second embodiment,

FIG. 11 is a flowchart illustrating a process until an image is formed on a recording medium based on inputted image data under the control scheme of the controller of FIG. 10,

FIG. 12 is a block diagram illustrating various functions of a further controller relating to the third embodiment of the invention, and

FIG. 13 is a flowchart illustrating a process until an image is formed on a recording medium based on inputted image data under the control scheme of the controller of FIG. 12.

### DESCRIPTION OF THE PREFERRED EMBODIMENTS

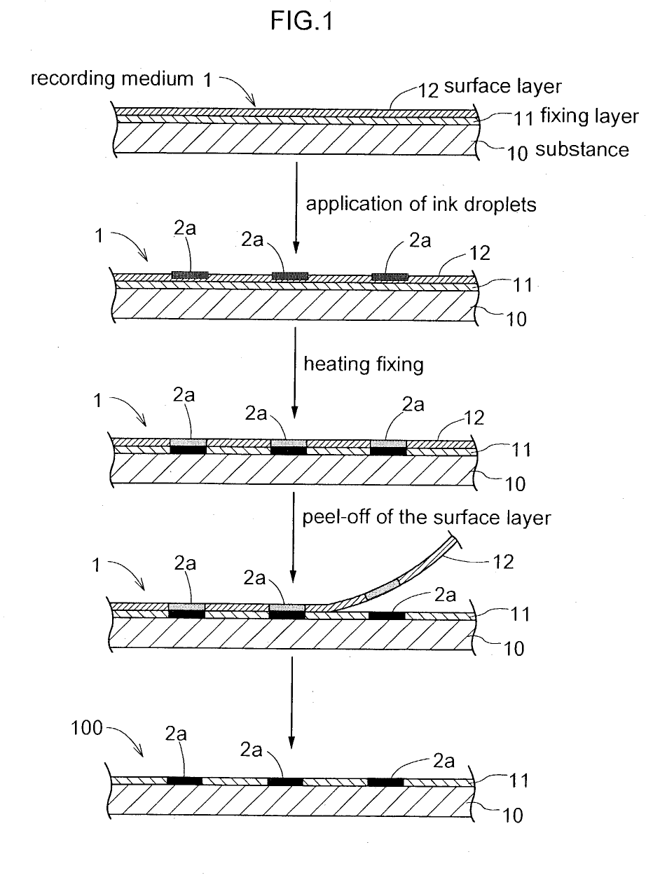

First, an example of a recording medium 1 to be processed by the invention's image forming apparatus will be described with reference to FIG. 1. This recording medium 1 includes a substrate 10 made of a film sheet of e.g. PET (polyethylene terephthalate), a fixing layer 11 formed of e.g. urethane resin and placed over the surface of the substrate 10 for fixing therein ink, that is, ink pigment, and a surface layer 12 placed on the surface of the layer 11 and acting as a permeation layer allowing permeation of the ink therethrough. In case the surface of the substrate 10 has a property allowing direct fixation of the ink pigment thereon, the fixing layer 11 may be omitted. In use, sublimating ink droplets are applied by e.g. an inkjet printer to the surface layer 12 of this recording medium 1 to form thereon a printed image constituted from un-sublimated print dots, after which, when heated to an appropriate temperature, the ink droplets (un-sublimated print dots) applied on the surface layer 12 begin to sublime and permeate the surface layer 12 to reach the underlying fixing layer 11, so that the ink pigment, now as sublimated print dots, is fixed within the fixing layer 11. Accordingly, by removing or “peeling off” the surface layer 12, there will be obtained, as a final printed product 100, an image recorded sheet having high gloss and high image definition bearing the printed image formed of the sublimated print dots in its fixing layer 11. Namely, in this heating sublimating process, the ink pigment applied as un-sublimated print dots to the surface layer 12 permeates through the surface layer 12 to reach the fixing layer 11, where the pigment as sublimated print dots forms the printed image. Incidentally, as this recording medium requires, at the last stage, removal of the surface layer 12 from the fixing layer 11 or the substrate 10, it will be advantageous to provide a releasing agent therebetween.

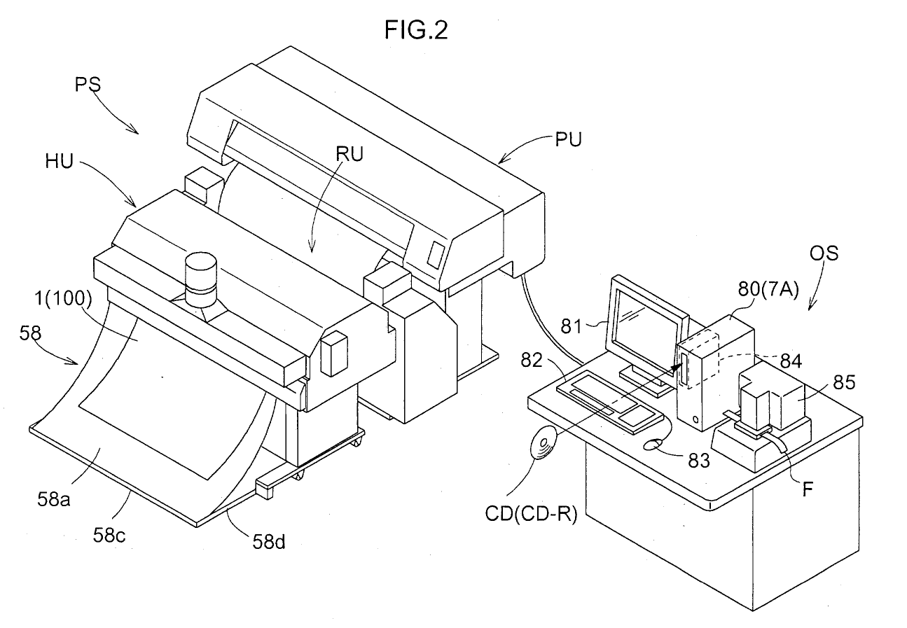

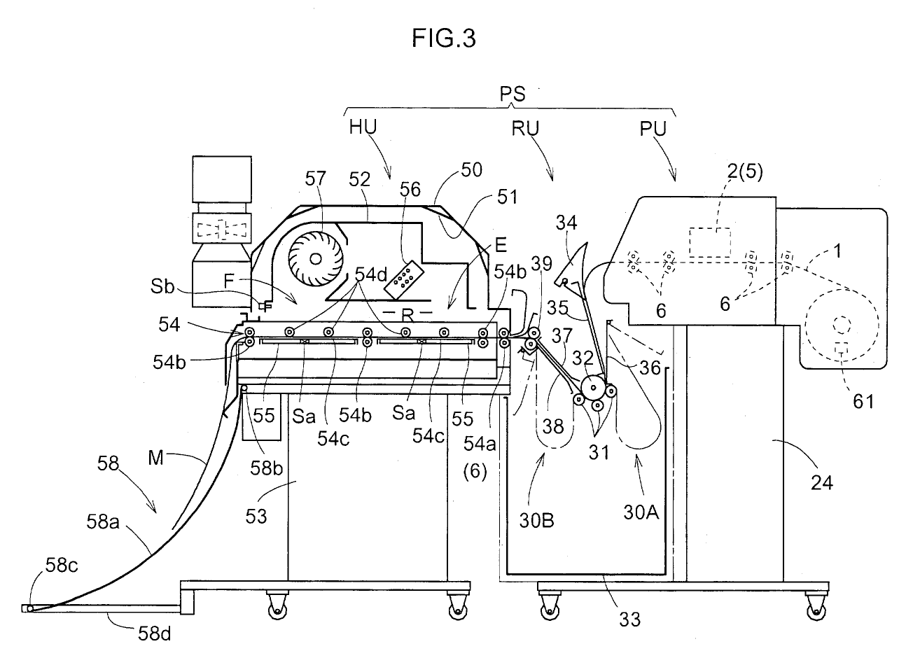

Next, an exemplary image forming apparatus for producing the final printed product 100 with using the above-described recording medium 1 will be described with reference to FIG. 2 and FIG. 3. As shown in FIG. 2, this image forming apparatus consists mainly of a printing station PS and an operator's station OS.

The printing station PS includes an inkjet type printing unit PU, a loop-forming unit RU for temporarily holding the recording medium 1 bearing a printed image formed of un-sublimated print dots by the printing unit PU, and a heating fixing unit HU (to be referred to simply as “heater device” hereinafter) for applying thermal energy to the recording medium 1 sent from the loop-forming unit RU to produce a printed image formed of sublimated print dots. In this, the loop-forming unit RU provided between the printing unit PU and the heater device HU serves to absorb a speed difference existing between a relatively low transport speed of the recording medium 1 provided by the heater device HU and a relatively high average transport speed of the medium 1 provided by the printing unit PU. The printing unit PU, loop-forming unit RU and the heater device HU are provided as separate units detachably connectable to each other. In the instant embodiment, the transport speed of the recording medium 1 by the heater device HU is about 300 mm/min. Whereas, the transport speed of the recording medium 1 by the printing unit PU will be actually determined based on such factors as a desired resolution of image data when printed (i.e. print data) to be obtained and the width of the recording medium 1 employed. But, the transport speed of the printing unit PU, even at its minimum, is still higher than the transport speed of the medium 1 by the heater device HU.

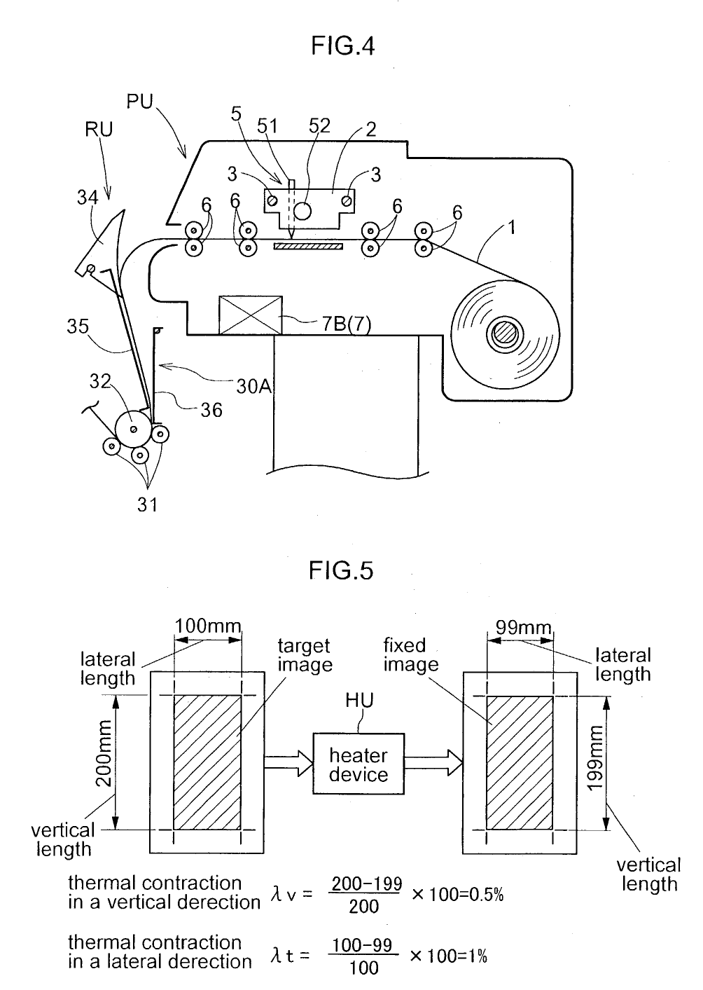

As can be seen from FIG. 4, within the printing unit PU, a sheet transport mechanism 6 transports the recording medium 1 while unwinding this recording medium 1 from an unillustrated roll-sheet cartridge in which the medium 1 is stored in the form of a roll, in such a manner that the surface layer 12, the printing surface, of the medium may be brought adjacent an ink discharging outlet of an inkjet type print head 2 as an example of a print head. The print head 2 is mounted to be movable back and forth by a head feeding mechanism 3 along a direction traversing the transporting direction of the recording medium 1, that is, along a main scanning direction. As the recording medium 1 is transported along a sub-scanning direction with each stroke of movement of the print head 2 discharging ink through its ink discharging outlet against the surface layer 12 of the recording medium 1, printed images will be formed in succession. The print head 2 includes a plurality of discharging outlet modules capable of respectively discharging inks of different principal colors in order to form a color printed image. For instance, if a color printed image of photographic quality is needed, in addition to inks of primary colors of cyan, magenta, yellow, black etc, further inks of tint colors of same kind will be generally used. The print head 2 may be a standard print head used in a conventional inkjet printer. Therefore, further description thereof will be omitted. After a printed image is formed on its surface layer 12 with the ink droplets 2a discharged from the print head 2, the recording medium 1 exits the printing unit PU to enter the loop-forming unit RU.

The recording medium 1 is provided in the form of an elongate sheet from its manufacturer. Hence, it is necessary to cut it to a size of a printed image formed thereof. To this end, a sheet cutter means 5 is provided. In this embodiment, the sheet cutter means 5 includes a cutter blade body 51 switchable between a position where the body projects toward the recording medium 1 relative to the print head 2 and a further position where the body is retracted away from the recording medium 1, and a switchover motor 52 for switching over the cutter blade body 51 between the two positions through e.g. a cam-feed or screw-feed mechanism (not shown).

Though shown only schematically in FIG. 3 the loop-forming unit RU includes a turn roller 32 having three driven rollers 31 at the center thereof, a first loop-forming mechanism 30A disposed transportation-wise downstream of the turn roller 32, a second loop-forming mechanism 30B disposed transportation-wise upstream of the turn roller 32, and a case 33 for receiving the recording medium 1 at a position downwardly of these components.

The turn roller 32 is driven by an unillustrated motor; and as its three driven rollers 31 are pressed against the outer periphery of this turn roller 32, the turn roller 32 winds the recoding medium 1 about it at a relatively large angle, so that this roller 31 provides an additional function for eliminating or adjusting any curling tendency present in the recording medium 1 as furnished from its manufacturer. The first loop-forming mechanism 30A includes an introduction guide 34 for downwardly guiding the recording medium 1 discharged from an exit of the printing unit PU, a first stationary guide 35 for further downwardly guiding the recording medium 1 which has been guided downwardly by the introduction guide 34 and a first movable guide 36 disposed in opposition to the first stationary guide 35. The first movable guide 36 is pivotable by means of an unillustrated motor about a pivot axis disposed at the top end of the guide, so that the guide 36 can selectively assume a closed posture denoted with a solid line or a opened posture denoted with a virtual line.

The second loop-forming mechanism 30B includes a second stationary guide 37 for guiding the recording medium 1, which has been transported from the first loop-forming mechanism 30A via the turn roller 32, to the heater device HU, a second movable guide 38 disposed in opposition to the second stationary guide 37, and a clamping type feed roller 39 for feeding the recording medium 1 to the heater device HU. The second movable guide 38 is pivotable by means of an unillustrated motor about a pivot axis disposed at the top end of the guide, so that the guide 38 can selectively assume a closed posture denoted with a solid line or a opened posture denoted with a virtual line.

In this loop-forming unit RU, at respective positions along the transport passage of the recording medium 1, sensors (not shown) are provided for detecting presence/absence of the recording medium 1 and a control operation described below is effected based on detection signals from these sensors. Namely, when the recording medium 1 is discharged from the printing unit PU, the first movable guide 36 is set to its closed posture and also the turn roller 32 is rotated at a low speed, thereby to guide the leading end of this recording medium 1 from the introduction guide 34 to the turn roller 32. Upon confirmation of clamped retention of the leading end of the recording medium 1 between the turn roller 32 and the driven rollers 32, the first movable guide 36 is switched over to its opened posture, whereby the recording medium 1 is stored under a suspended condition within the first loop-forming mechanism 30A. Next, upon detection of the tailing end of the recording medium 1 transported from the printing unit PU, the second movable guide 38 is set at its closed posture and under this condition, the control initiates driving of the turn roller 32 and the feed roller 39, thereby to transport the leading end of the recording medium 1 to the feed roller 39 of the second loop-forming mechanism 30B, so that the feed roller 39 clamps the leading end of the recording medium 1 and proceeds to send the medium into the heater device HU at a speed substantially equal to the transport speed of the recording medium by the heater device HU and at the same time, after switching over the second movable guide 38 to its opened posture, the turn roller 32 is driven to rotate at a high speed, whereby the recording medium 1 retained within the first loop-forming mechanism 30A is stored under a suspended condition within the second loop-forming mechanism 30B. In this way, upon sending of the recording medium 1 from the first loop-forming mechanism 30A into the second loop-forming mechanism 30B, the control operation is resumed for introducing the recording medium 1 from the printing unit PU into the first loop-forming mechanism 30A in the manner described above.

As schematically shown in FIG. 3, the heater device HU includes, within a main casing 50 thereof, a heating case 51 made of insulating material for heating the recording medium 1, a blower case 52 also made of insulating material and disposed above the heating case 51 for supplying hot air to this heating case 51, and a support leg 53 for supporting the main casing 50. With a heating space R formed inside the heating case 51, there is disposed a heating transport mechanism 54 for transporting the recording medium 1, the heating transport mechanism 54 constituting a part of the sheet transport mechanism 6. This heating transport mechanism 54 includes a pair of clamping type introducing rollers 54a disposed at the entrance for the recording medium 1, a plurality of transport rollers 54d disposed transportation-wise downstream of the introducing rollers 54a and adapted for clamping the recording medium 1 from opposed sides thereof for transporting it, a pair of guide members 54c disposed respectively at transportation-wise upstream and downstream positions and adapted for contacting the lower side of the recording medium 1 for transmitting heat thereto, and a plurality of upper-side contacting rollers 54b disposed upwardly of the guide members 54c and adapted for contacting the upper side of the recording medium 1 for providing a transporting force thereto. Further, the each guide member 54c mounts, on its bottom face thereof, a sheet heater 55 for heating this guide member 54c and a guide temperature sensor Sa disposed at the center of the sheet heater 55 for sensing the temperature of the guide member 54c.

Inside the blower case 52, there are provided an electric heater 56 in the form of a plurality of rods and a crossflow fan 57 for driving fan blades about an axis extending parallel with the width of the recording medium 1 for feeding hot air. This blower case 52 defines, in its bottom face, an outlet E located immediately below the crossflow fan 57 for discharging hot air and an inlet F located downstream on the transporting passage for the recording medium 1 by the heating transporting mechanism 54. Adjacent the aperture of the outlet E, there is provided an air sensor Sb in correspondence with the crossflow fan 57. Incidentally, power is supplied to the electric heater 56 so that the upstream guide temperature sensor Sa may sense temperature of about 180° C. and power to the sheet heater 55 is supplied so that the upstream guide sensor Sa may sense temperature of about 130° C. and also the downstream guide temperature sensor Sb may sense temperature of about 180° C.

When the recording medium 1 is heated, the electric heater 56 and the crossflow fan 57 are driven, thereby to feed the air heated within the blower case 52 through the outlet E to a position transportation-wise downstream of the recording medium 1 inside the heating case 51 for a feeding width greater than the entire width of the recording medium 1, so that this hot air is caused to flow in the heating space R toward the transportation-wise upstream side along the transporting passage of the recording medium 1. Then, the air is drawn into the blower case 52 through the inlet F at a position transportation-wise upstream of the recording medium 1 to be heated by the electric heater 56. After this, the heated air is supplied to the crossflow fan 57. In this way, the heated air is circulated.

In order to receive the recording medium 1 discharged from the heating space R, as shown in FIGS. 2 and 3, there is provided a stocker 58 comprising a stocker sheet 58a made of cloth and disposed with an inclination. This stocker sheet 58a has a width greater than the maximum width of the recording medium 1 which can be processed by the heater device HU and is formed of polyester cloth having high heat resistance and interwoven with carbon fibers having conductivity for eliminating static electrical charge. Also, this stacker sheet 58a has its top end supported to a horizontal support rod 58b and has its bottom end supported to a bottom rod 58c. The bottom rod 58c has its opposed ends supported by stays 58d extending from the support leg 53 of the heater device HU. With this, the stocker sheet 58c is inclined downwardly in a direction farther from the heater device HU. In the recoding medium 1 which has been discharged to the stocker 58 through the heater device HU, the ink (pigment) forming its printed image are already fixed within the fixing layer 11. Then, by removing the surface layer 12, a finished printed product 100 having a clearly color-developed image may be obtained.

With the sublimating type inks used in the printing unit PU, during the heating sublimation process after the above-described application thereof to the recording medium, the sublimation generally begins at about 80° C. and the sublimated and fixed condition thereof may be obtained with a heating period of about 2 minutes at a heating temperature of 180° C.

In the course of the heating fixing process described above, the recording medium 1 is subjected to a large amount of thermal energy at a considerably high rate. As a result, since the substrate 10 of this recording medium 1 is made of synthetic resin such as PET (polyethylene terephthalate) or the like, there will occur a size difference between the recording medium 1 before its introduction to the heater device HU and the same medium 1 which has been discharged from the heater device HU and placed on the stocker 58.

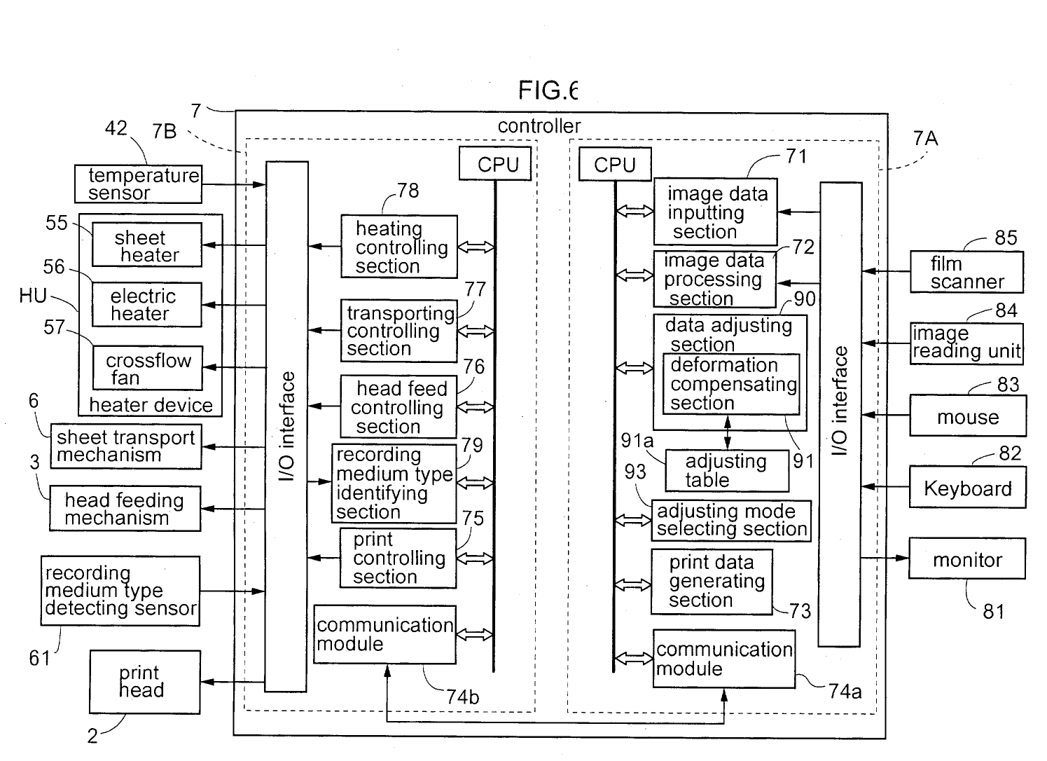

The specific mode of thermal deformation may vary depending on the kind of the material employed. As one example thereof, the following case refers to occurrence of thermal contraction. As shown in FIG. 5, thermal contraction of 0.5% in the vertical direction and 1% in the lateral direction occurs in the medium 1 in the recording medium which has experienced the heating fixing process in the heater device HU relative to the same medium prior to that process. That is to say, even if a target image having a vertical length of 200 mm was intended, the image actually formed and fixed on the finished printed product 100 has a vertical length of only 199 mm. Similarly, even if the target image having a lateral length of 100 mm was intended, the image formed and fixed on the actual printed product 100 has a lateral length of 99 mm. For this reason, there will occur a displacement in the positions of the image of register marks by the amount corresponding to the thermal contraction. In the case of a large image size (large inter-mark distance), such displacement will become a serious problem when this image is to be affixed to or combined with another image element. In order to avoid this problem, that is, in order to obtain a finished printed product 100 having the exactly intended image size, it is necessary to calculate in advance the contraction amount of the recording medium 1 and then revise the image data in order to compensate for such thermal contraction. In the above-described case, since the contraction ratios are 0.5% for the vertical direction and 1% for the lateral direction, the image data will be subjected to an enlarging processing for obtaining an extended vertical length of 201 mm and an extended lateral length of 101 mm. Then, an image produced in the printing unit PU based on this “enlarged” or “extended” image data will obtain a vertical length of about 200 mm and a lateral length of about 100 mm after the heating and fixing process thereof in the heater device HU.

Basically, the thermal contraction ratios can be determined in accordance with the type of recording material 1 and the amount of heating energy to be applied thereto. Therefore, if vertical contraction ratios and lateral contraction ratios of all usable kinds of recording mediums 1 are tabulated and stored in advance in the image forming apparatus to allow automatic adjustment of the image data for thermal deformation compensation, the operator of the apparatus may be free from concern about this thermal deformation problem.

However, such thermal contraction ratios may vary depending on the environment where the image forming apparatus is installed or it may even be desired to use a special type of recording medium 1 whose contraction ratios are not tabulated or stored therein. Hence, an alternative construction which allows manual on-site input of contraction ratios may be also advantageous. Specifically, for input of contraction ratios, a test print will be obtained for an appropriate image whose resultant print size is known. Then, the dimensions of its fixed image are measured to obtain the contraction ratios, which then may be input to the apparatus. Alternatively or in order to alleviate the operator's trouble for such operations, it is possible to provide the image forming apparatus to be provided in advance with image data as shown in FIG. 5 (this image may be the register marks alone) as test-print data. Then, by using this test-print data, a finished printed product 100 will be produced. Then, the inter-mark distances in the vertical and lateral directions may be inputted manually to the apparatus. Or, the resultant image may be read by a scanner to obtain the inter-mark distances in the vertical and lateral directions. Then, the image forming apparatus may calculate contraction ratios based on the distances, so that the apparatus may use the ratios just like the other tabulated contraction ratios.

A controller 7 functioning as a control unit for the image forming apparatus having the above-described construction includes a first controller 7A provided in the operator's station OS and a second controller 7B provided in the printing station PS, with the two controllers 7A, 7B being connected to each other via communication cable for allowing data exchange therebetween, so that the two controllers 7A, 7B may function just like a single controller.

As shown in FIG. 2, the operator's station OS includes a general-purpose computer 80 acting also as the first controller 7A, a monitor 81, a keyboard 82, a mouse 83, a film scanner 85 for effecting photoelectric conversion of a photographic image of a developed silver-salt type photographic film F into color image data, and an image reading unit 84 (in this case, this unit is incorporated within the computer 80) for reading or obtaining color image data from a data storage medium (CD, CD-R, MO, or any kind of semiconductor memory device such as Compact-Flash or Smart-Media as well as any communication media comprising a data communication line). In the case of this image forming apparatus, the image data obtained by the film scanner 85 or the image reading unit 84 and then transmitted to the first controller 7A will be subjected to various data processing operations including the enlarging processing (or reducing processing) for deformation compensation and then the processed image data will be transmitted as source print data to the second controller 7B, so that a printed image will be formed on the recording medium 1 at the printing station PS.

As described above, the controller 7 includes the first controller 7A and the second controller 7B each having as a major component thereof a microcomputer system having CPU, ROM, RAM, I/O interface circuit etc., and the second controller 7B. As shown in FIG. 6, to the first controller 7A, via the I/O interface circuit, there are connected such peripheral devices as the image reading unit 84, the film scanner 85, etc. To the second controller 7B, via its I/O interface circuit, there are connected the peripheral devices incorporated in the printing station PS including the inkjet print head 2, the head feeding mechanism 3, the electric heater 56, the crossflow fan 57, the recording medium transporting mechanism etc. Further, a recording medium type detecting sensor 61 is provided for detecting an ID code provided on the roll sheet cartridge or on a shaft member supporting the recording medium 1 around it in the rolled state and this sensor transmits its type detection signal to the controller 7, so that the controller 7 may recognize the type of the charged recording material 1 based on this detection signal. The first controller 7A and the second controller 7B are capable of data transmission via respective communication modes thereof. For instance, the image data having been subjected to the image processing and adjustment processing at the first controller 7A will be converted into final print data, which will then be transmitted to the second controller 7B via the communication module 74a, 74b to be subsequently used for e.g. application of the sublimating ink to the recording medium 1.

The various functions provided by the controller 7 are realized by means of hardware and/or software. Referring here to only those functional elements having relevance to the present invention, the following sections are provided as typical examples; namely, an image data inputting section 71 for effecting pre-processing on the image data obtained by the image reading unit 84 or the film scanner 85 such as a format conversion or resolution conversion; an image processing section 72 for effecting image adjustments on the image data transmitted from the image data inputting section 71 such as a trimming or color adjustment; a data adjusting section 90 for making adjustments on the image data in order to compensate for the disadvantageous effect on the image formation from the thermal load application as described hereinbefore; a print data generating section 73 for generating source print data for subsequent use by the print head 2 from the final image data after the standard image processing as well as the reducing or enlarging processing for deformation compensation by implementing a binarizing method such as an error diffusing method; a print controlling section 75 for driving the print head 2 in accordance with the transmitted print data for discharging ink droplets through the outlet; a head feed controlling section 76 for moving the print head 2 along the main scanning direction by using the head feed mechanism 3 in synchronism with driving of the print head 2; a transportation controlling section 77 for controlling the intermittent feeding of the recording medium 1 in synchronism with the movement of the print head 2 along the main scanning direction within the printing unit PU, the looped transportation of the recording medium 1 within the loop-forming unit RU as well as the heating transportation of the recording medium 1 within the heater device HU; a heating controlling section 78 for controlling the driving of the electric heater 56 and the crossflow fan 57 of the heater device HU; and a recording medium type identifying section 79 for obtaining type data of the charged recording medium 1 based on the ID code thereof read by the recording medium type detecting sensor 61.

In this embodiment, the data adjusting section 90 includes a deformation compensating section 91 for adjusting in advance the size of the source image data by an amount of thermal deformation expected to occur in the recording medium in order to compensate for a size difference between a target image and a fixed image to be formed finally on the finished printed product.

The deformation compensating section 91 is linked with an adjustment table 91a storing therein vertical and lateral contraction ratios (expansion or elongation ratios in case the recording medium 1 is thermally expanded) for respective types of recording media 1. Therefore, based on the type data obtained from the recording medium type identifying section 79, the deformation compensating section 91 specifies the type of the recording medium 1 currently used and extracts its vertical and lateral contraction ratios from the adjustment table 91a with using the specified type as a search key and then executes a size changing process (in this case, an enlarging process) on the subject source image data so as to achieve agreement between the image size after the thermal deformation and the target image size.

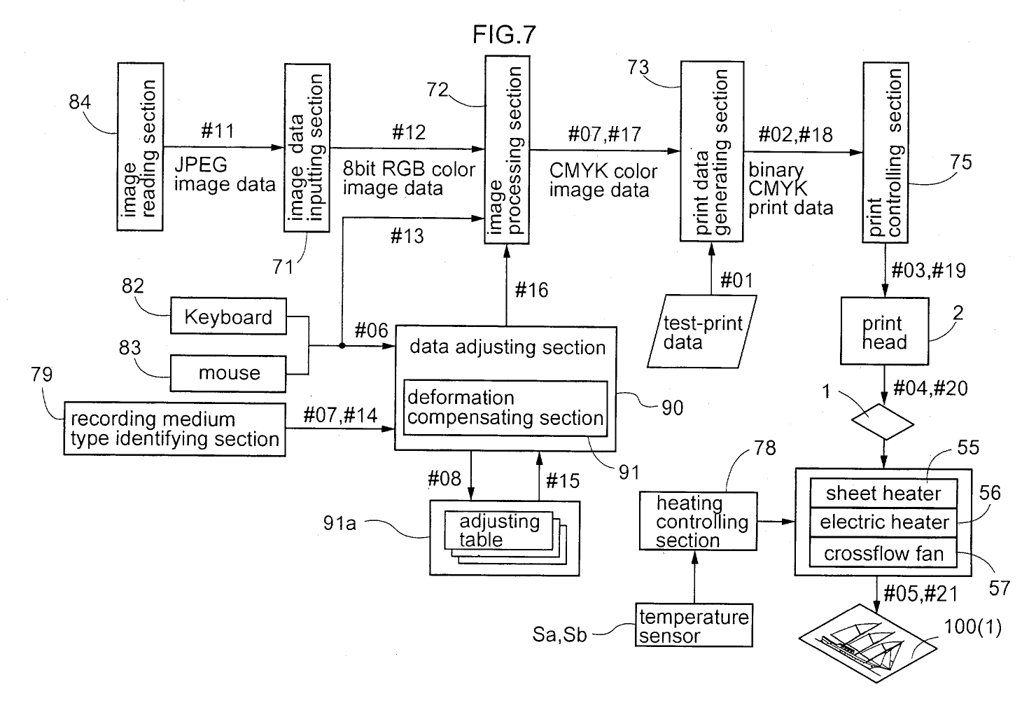

Next, with reference to the schematic flowchart of FIG. 7, there will be described a process for forming an image on a recording material 1 of a special type whose contraction or expansion ratios are not stored within the adjustment table 91a, based on image data read from the MO disc obtained by means of the image reading unit 84.

If this recording medium 1 to be used is a thermally contractible type, the process begins with writing of contraction ratios of this recording medium 1 into the adjustment table 91a. Specifically, test-print data for an image having the register marks shown in FIG. 5 are extracted from a predetermined folder or CD-ROM (#01) and then transmitted via the print data generating section 73 to the print controlling section 75 (#02). The print controlling section 75 produces drive pulse signals for the print head 2 from the received binary CMYK print data (#03) and controls the drive elements of the print data 2 with the signals to jet ink droplets against the recording medium 1. At the same time, the transportation controlling section 75 controls driving of the head feed mechanism 3 and the transportation controlling mechanism 77 controls driving of the transport mechanism 6, whereby a test print image is formed on the recording medium (#04). Then, as the resultant recording medium 1 having the photographic image formed on its surface layer 12 is caused to pass the heating space R whose temperature is appropriately adjusted, the medium receives the thermal energy and with associated heating sublimation, so that the test print image is transferred (fixed) onto the fixing layer 11 (#05). With this, a test print sheet having a fixed image thermally contracted from the target image is obtained.

Then, the size of this test print image, i.e. the vertical inter-register mark distance and the lateral inter-register mark are measured and these measured values are inputted to the deformation compensating section 91 via the keyboard 82 (#06). As the deformation compensating section 91 has stored therein the original image size of the test print image, i.e. the target image, the contraction ratios of this recording medium 1 may be calculated based on this target image size and the measured image size. The calculated contraction ratios are then stored at the adjustment table 91a in correlation with the type code of the used recording medium 1 determined based on the type data (#07) received from the recording medium type identifying section 79 (#08).

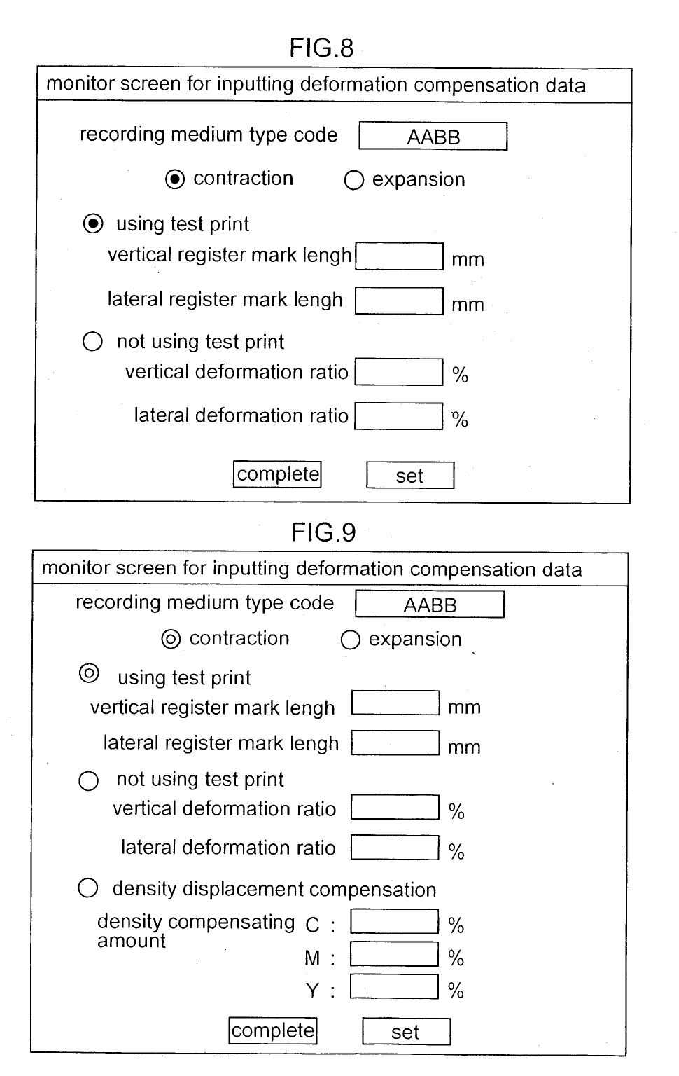

An example of monitor screen for inputting measured image size is illustrated in FIG. 8. When the type code of the recording medium 1 to be used is recognized based on the type data from the recording type identifying section 79, this type code will be displayed. Otherwise, a question mark will be displayed for prompting input of an appropriate type code or input of data for the present deformation compensation alone without effecting the registration of the code in the adjustment table 91a. Since some types of recording medium 1 are thermally contractible while others are thermally expandable, selection is made between these types and a further selection is made between the input of deformation compensation using the above-described test print and the input of deformation compensating not using the test print. In case the test print is used, as described above, the measured vertical register mark length and the lateral register mark length will be inputted. On the other hand, when the test print is not used, a vertical deformation ratio (contraction or expansion ratio) and a lateral deformation ratio obtained in advance through some appropriate method will be inputted.

Next, the image data in the JPEG format read from the MO disc by means of the image reading unit 84 are transmitted as image source for this image forming apparatus to the image data inputting section 71 (#11). At this image data inputting section 71, the JPEG image data are mapped into 8-bit RGB color image data (bit-map data) and then transmitted to the image processing section 72 (#12). Then, the image data are processed in accordance with the print size, trimming setting command, color adjustment command etc. inputted by the operator by operation of the keyboard 82 or the mouse 83 (#13).

Upon completion of the predetermined image processing, the deformation compensating section 91 makes an access to the adjustment table 91a by using the type code determined based on the type data (#14) received from the recording medium type identifying section 79 to obtain contraction ratios of the recording medium 1 to be used (#15). Further, based on the obtained contraction ratios, the deformation compensating section 91 effects an enlarging processing on the processed image data as an image data adjustment for deformation compensation so that the size of the fixed image to be obtained may precisely correspond to the target image determined by the source image in spite of thermal contraction to occur in the heating fixing process (#16).

Then, the image data after the image data adjustment for deformation compensation at the image processing section 72 will be transmitted to the print data generating section 73 (#17). Incidentally, since the RGB color data have already been converted into the CMYK color image data at an appropriate stage after or before the other image processing, the color data transmitted to the print data generating section 73 are CMYK color image data. At this print data generating section 73, the CMYK color image data are converted into binary CMYK print data, which are then transmitted to the print controlling section 75 (#18). As described hereinbefore, the print controlling section 75 generates drive pulse signals for the print head 2 from the transmitted binary CMYK print data (#19), whereby the drive elements of the print head 2 are controllably driven to form an image on the recording medium 1 with ink dots (#20). The resultant recording medium 1 having the photographic image formed on its surface layer 12 is caused to pass the heating space R which is appropriately temperature-conditioned, during which the medium receives the thermal energy and with associated heating sublimation, the test print image is transferred (fixed) onto the fixing layer 11 (#21). Although this fixed image has shrunk due to thermal contraction from its previous size when formed by the print head 2 (#20), the image size was enlarged in advance from the target image size with consideration to the thermal contraction, so that the size of the fixed image formed on the final printed product 100 will agree with the target image size.

As described above, the difference between the target image size and the actual fixed image size resulting from thermal deformation occurring in the recording medium 1 can be effectively compensated for by adjusting (reducing or enlarging) the source image data by an amount of that difference. However, if the recording medium 1 undergoes a significant amount of thermal deformation, non-negligible displacement may occur in the image density also. This is because of the following reason. Namely, if the medium represents color density in terms of area gradation of some particular colors (generally, CMYK) for instance, thermal contraction of the recording medium 1 tends to cause relative increase of the pigment amount per unit area, leading to increased color density; and conversely thermal expansion (or elongation) thereof tends to cause relative decrease in the amount, leading to decreased color density.

For this reason, it will be advantageous if the deformation compensating section 91 makes an adjustment of the density value of the image data so that the density of the image data may be reduced in advance in the case of the density of the final fixed image tending to be higher and the density of the image data may be increased in advance in the case of the density of the final fixed image tending to be lower. In this case, needless to say, the adjustment table 91a is to store density adjusting amounts for respective colors in addition to the above-described contraction ratios (or expansion ratios) for the various respective type of recording media 1. For obtaining such density adjusting amount for use in the thermal deformation compensation relating to the density, a test print data having e.g. a well-known color chart used for the purpose of e.g. color matching may be used for forming and fixing a test image on the subject recording medium 1. Then, density of this image will be determined by means of e.g. densitometer and the adjusting amount may be calculated based on a difference between the known density of the target image and the measured density of the fixed test image.

In this case too, if a special type of recording medium 1 whose density adjusting amount is not stored in the adjusting table 91a, test print data will be inputted to the apparatus (if this test print data is caused to include the above-described register marks in addition to the color chart, this will allow simultaneous measurements of the image size and the image density advantageously) to produce a test print and its density adjusting amount will be calculated. Preferably, the density adjusting amount thus obtained may be inputted at the same time as the input of the inter-register mark lengths, preferably obtained simultaneously, for use in the deformation compensation regarding the image size. For this reason, a deformation compensation data input screen relating to this embodiment, as shown in FIG. 9, includes additional cells for allowing input of density adjusting amounts.

Instead of adjustment of the density value of image data, the above-described density displacement compensation is also possible by modifying a conversion expression, e.g. a conversion matrix, to be used by the print data generating section 73 when converting the CMYK color image data into the binary CMYK print data using the area gradation technique.

In that case, the deformation compensating section 91 may be adapted to provide an area gradation change setting command to the print data generating section 73 in accordance with the type of recording medium 1 to be used.

Incidentally, regarding the above-described displacement compensation occurring between a target image and a fixed image, if the displacement of the image density alone is not negligible, then, the deformation compensating section 91 may have only the function for the density displacement compensation.

### Further Embodiments

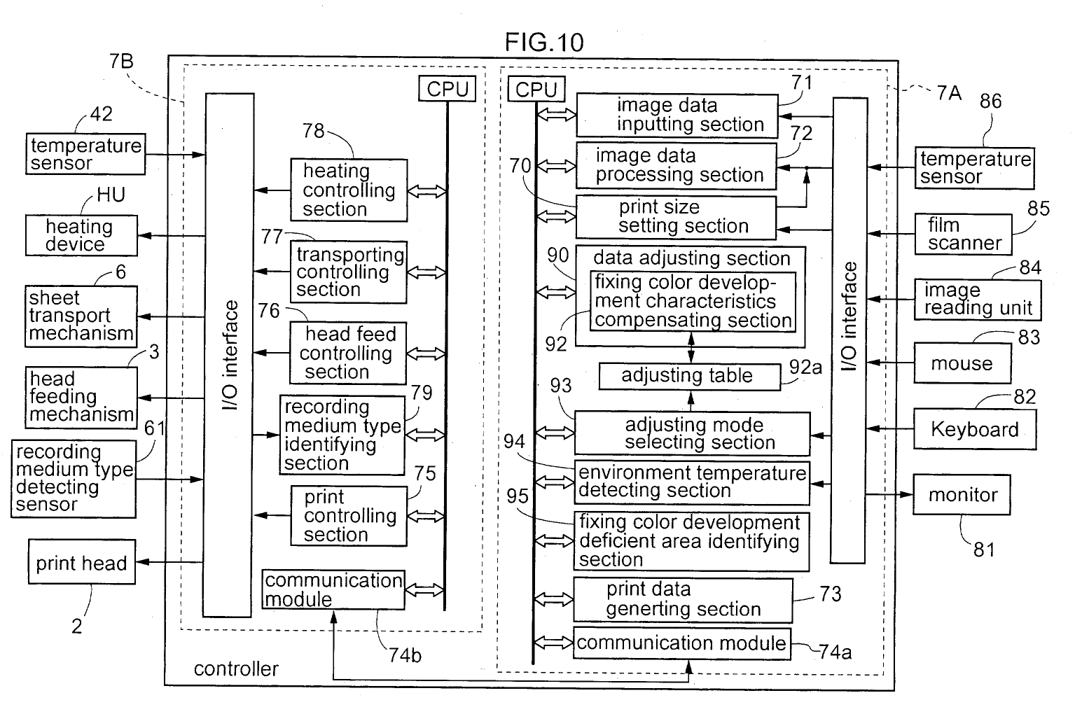

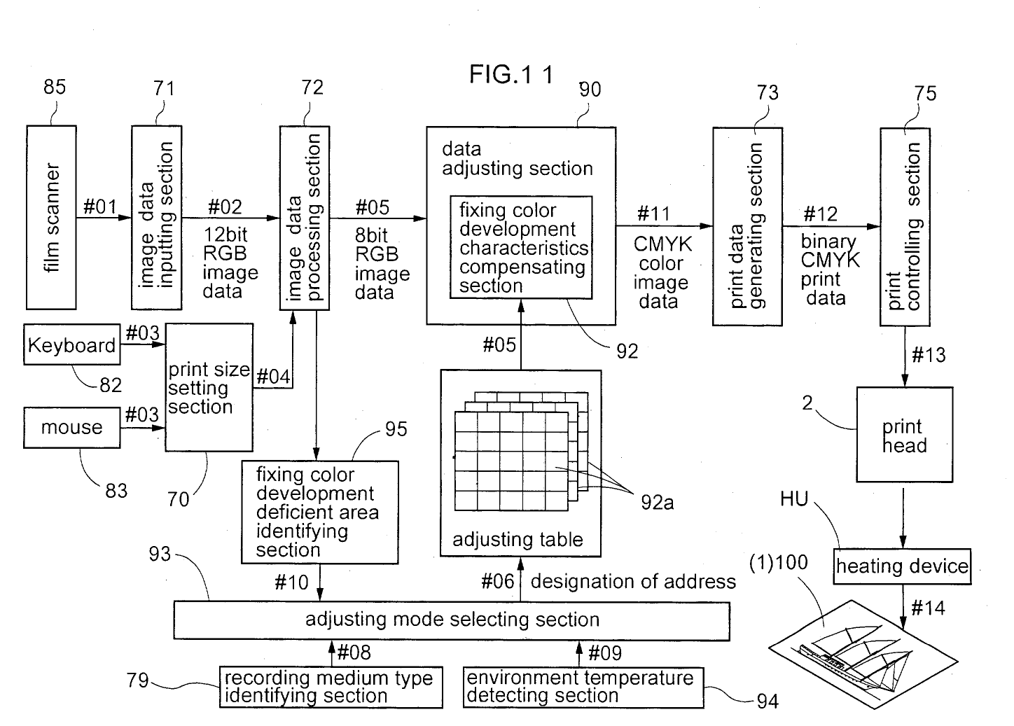

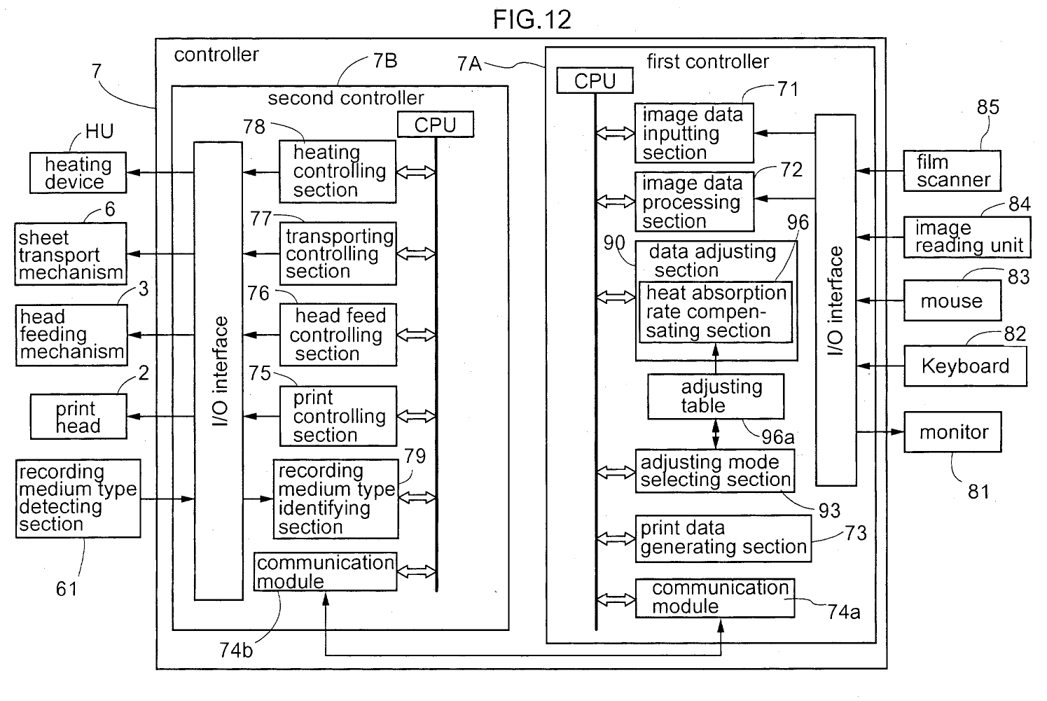

FIG. 10 shows a controller 7 relating to the second embodiment. Here, the controller includes a fixing color development characteristics compensating section 92 for compensating for deterioration in fixing color development characteristics occurring under certain conditions. For instance, if the density value of the print dot formed on the recording medium with ink droplet from a print head such as an inkjet print head varies, such variation is estimated and the density value of color image data as the print course is to be adjusted in advance in order to compensate for such variation. If insufficient density occurs in the print dot due to the original characteristics of the recording medium or of the heater device HU, by effecting adjustment for increasing in advance the density value of the color image data, the density of the resultant print dot may become appropriate (i.e. appropriate fixing color development characteristics). An adjustment table 92a for use in such fixing color development characteristics compensation is prepared through experiments for each of conditions which may affect the fixing color development characteristics and then stored in a memory to be subsequently selected, when needed, by an adjustment mode selecting section 93 for use by the fixing color development characteristics compensating section 92.

Although this adjustment table 92a actually includes other adjustment data for well-known image processing such as color adjustment, sharpness, etc, only its fixing color development adjustment data will be described next.

The conditions in the heating space may vary depending on each image forming apparatus or even on individual unit of the heater device HU and a certain amount of tint displacement may occur in the resultant print image. For this reason, a print test is conducted in advance, with using a test print pattern image. By comparing the resultant print image and a prepared ideal image, an adjustment ratio for the color image data needed for compensation for the difference therebetween is obtained and based on this fixing color development adjustment data are produced. This adjustment data becomes the basic adjustment table 92a for the fixing color development characteristics compensation.

The fixing color development characteristics of the recording medium 1 per se may often vary, depending on the manufacturer or may vary also depending on the size of the medium even of a same manufacturer. Therefore, a print test is conducted for each type of recording medium 1. Then, the fixing color development adjustment table 92a will be prepared and stored for each of a plurality types of recording media 1. From this table, depending on the type of the recording medium 1 determined by the recording medium identifying section 79, the adjustment mode selecting section 93 selects an appropriate adjustment table 92a and loads the selected table to the fixing color development characteristics compensating section 92.

Further, even if the individual unit difference of the heater device HU can be compensated for, the heating behavior of such heater device HU can still be affected considerably by the environment temperature unless the device is installed in a large insulated space free from such. For this reason, a test print is effected for each predetermined environment temperature and the fixing color development compensation adjustment table 92a is produced and stored for each particular type of recording medium 1. From this table, depending on the environment temperature determined by an environment temperature detecting section 94, the adjustment mode selecting section 93 may select an appropriate adjustment table 92a and load the selected table to the fixing color development characteristics compensating section 92.

Further, in some cases, it is also required to consider displacement in the fixing color development characteristics due to heating irregularity or drying irregularity or both occurring in the heating process of the recording medium 1. As such heating or drying irregularity occurs only locally in the recording medium 1, uniform overall adjustment will not be desirable. Hence, in order to compensate for this type of displacement, such particular limited area in the recording medium 1 where the heating and/or drying irregularity will likely occur will be checked in advance by means of e.g. test print. And, the fixing color development compensation adjustment table 92a should be produced with masking of the remaining area. That is to say, if a reduced dot density value is observed in a particular limited area of the recording medium due to heating and/or drying irregularity, adjustment will be made for increasing the density value of the color image data corresponding to such limited area alone.

Moreover, when the sublimating type ink is heated and sublimed to be fixed in the fixing layer, water contained in the ink is evaporated. And, this water evaporation absorbs a certain amount of the thermal energy. As a result, the desired density may not be obtained in an area or areas where the ink dots are distributed with densities above a predetermined level. In order to compensate for this, such image data area with print dot distribution of a level above the predetermined level will be interpreted as a fixing color development deficient area. Then, the fixing color development compensation adjustment table 92a will be produced for adjusting the density value of the pixels belonging in that area in such a manner as to achieve the appropriate fixing color development characteristics consequently. Such fixing color development deficient area can be recognized by a fixing color development deficient area identifying section 95 which can be produced by the known programming technique in the filed of image processing art.

Ideally, all of the above-described fixing color development compensation adjustment tables 92a should be utilized. Needless to say, however, only some of them may be actually utilized. Incidentally, in case e.g. a conventional inkjet print paper not requiring any heating fixing process is employed as the recording medium 1, this fixing color development characteristics compensation can be omitted at all by using the adjustment mode selecting section 93 which can be operated by an operator via the keyboard 82 or the like.

Next, in connection with this second embodiment, with reference to the flowchart of FIG. 10, there will be described a process until a photographic image is formed on the recording medium 1 with using color image data of a photographic image read from a color negative film F by using the film scanner 85.

When the film scanner 85 has read the color negative film F, output signals from CCD of this film scanner 85 are amplified and then A/D converted into 12-bit RGB color image data, which are then transmitted to the image data inputting section 71 (#101). After subjecting to typical adjustment as scanner data such as gamma control at the image data inputting section 71, the data are transmitted to the image processing section 72 (#102). Before or after this process, the operator operates the keyboard 82 and/or the mouse 83 while reading a print order slip from the customer to input a designated print image size and this print image size is set to the print size setting section (#103).

The image processing section 72 effects a resolution conversion and/or trimming, if needed, on the received color image data, corresponding to the finished print size, based on the print image size received from the print size setting section (#104) and also converts the 12-bit data into 8-bit data and transmits the latter to the data adjusting section 90 (#105).

At the data adjusting section 90, in addition to the color adjustment routinely effected for digital photographic printing, the above-described amendment for the fixing color development characteristics compensation is effected by the fixing color development characteristics compensating section 92. First, upon address assignment therefor from the adjustment mode selecting section 93 (#106), the basic adjustment table 92a relating to the fixing color development compensation is loaded to the fixing color development characteristics compensating section 92 (#107).

Also, further fixing color development characteristics compensation adjustment according to the type of the recording medium 1 is effected as the adjustment mode selecting section 93 loads the appropriate adjustment table 92a to the fixing color development characteristics compensating section 92, based on the recording medium type information obtained from the recording medium type determining section 79 (#108). Similarly, still further color development characteristics compensation adjustment according to the environment temperature is effected as the adjustment mode selection section 93 loads the appropriate adjustment table 92a to the fixing color development characteristics compensating section 92, based on the environment temperature information obtained from the environment temperature detecting section 94 (#109). Moreover, in case a further adjustment table 92a is prepared with consideration to another type of fixing color development characteristics displacement due to heating and/or drying irregularity, this table too will be loaded to the fixing color development characteristics compensating section 92 for effecting compensation for heating and/or drying irregularity.

Furthermore, if the fixing color development deficient area identifying section 95 has identified a fixing color development deficient area in the color image data as the print source, information relating to this fixing color development deficient area is transmitted to the adjustment mode selecting section 93 (#110) and based on this, the adjustment mode selecting section 93 loads the appropriate adjustment table 92a with masking with the information relating to the fixing color development deficient area to the fixing color development characteristics compensating section 92 for making such adjustment. Incidentally, the above function of the fixing color development deficient area identifying section 95 may be incorporated within the adjustment table 92a for effecting adjustment of a density value in case a predetermined density value is distributed with a predetermined distribution density, so that this adjustment may be made like a filter processing.

Upon completion of all needed color image data adjustments at the data adjusting section 90, the resultant adjusted color image data is transmitted to the print data generating section 73 (#111). Incidentally, since the RGB color data have already been converted into the CMYK color image data at an appropriate stage after or before the other image processing at the data adjusting section 90, the color data transmitted to the print data generating section 73 are CMYK color image data.

Then, the print data generating section 73 effects a binarizing processing on the received 8-bit CMYK color image data to form gradation for the area gradation by the print head 2, thereby to generate binary CMYK print data and transmits this to the print controlling section 75 (#112).

The print controlling section 75 produces, from the received binary CMYK print data, driving pulse signals for the print head 2 and controls the driving elements of the print head 2 with these pulses for jetting ink droplets against the recording medium 1. At the same time, the head feed controlling section 76 controllably drives the head feed mechanism 3 and the transport controlling mechanism 77 controllably drives the transportation mechanism, whereby a photographic image is gradually formed on the recording medium (#113).

The resultant recording medium 1 having the photographic image formed thereon is caused to pass the heating space of the heater device HU whose inside temperature is adjusted by the heating controlling section 78 which is set to a control target temperature, whereby the image is heated and fixed in the recording medium (#114). As the appropriate fixing color development adjustment compensations have been effected, a finished printed product 100 having the desired tint may be obtained.

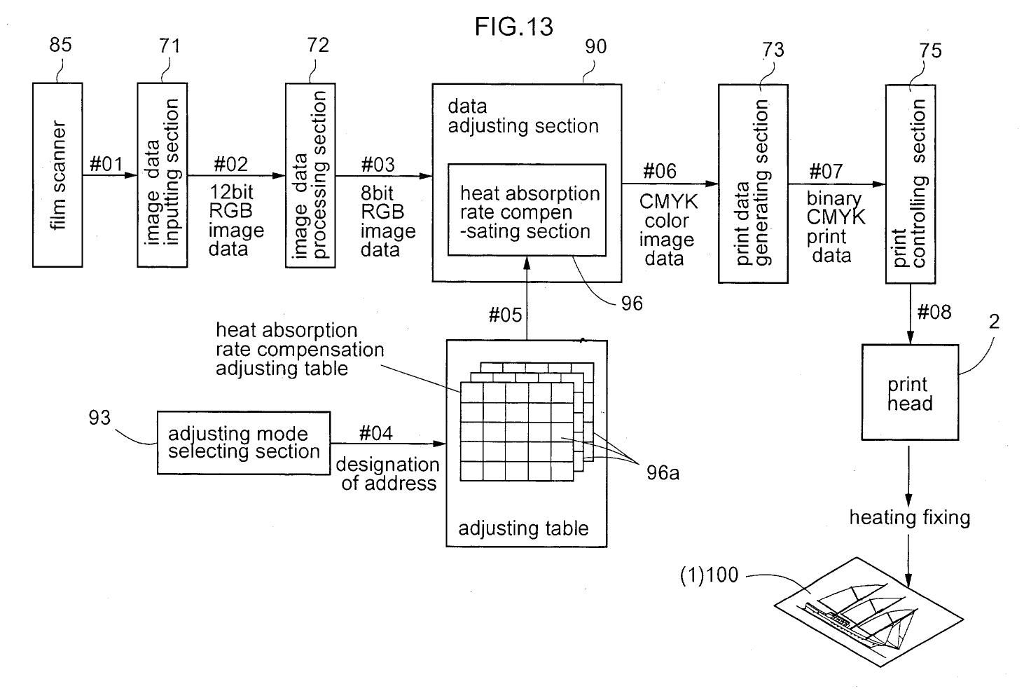

FIG. 13 shows a controller 7 relating to the third embodiment of the present invention. In this embodiment, the controller includes a heat absorption rate compensating section 96 for effecting adjustment on a particular color in order to compensate for a difference in the heat absorption rate of a radiant heat beam dependent on the color of the ink.

Next, in connection with this third embodiment, with reference to the flowchart of FIG. 14, there will be described a process until a photographic image is formed on the recording medium 1 with using color image data of a photographic image read from a color negative film F by using the film scanner 85.

When the film scanner 85 has read the color negative film F, output signals from CCD of this film scanner 85 are amplified and then A/D converted into 12-bit RGB color image data, which are then transmitted to the image data inputting section 71 (#201). After subjecting to typical adjustment as scanner data such as gamma control at the image data inputting section 71, the data are transmitted to the image processing section 72 (#202). The image processing section 72 effects a resolution conversion and/or trimming, if needed, on the received color image data, corresponding to the finished print size and also converts the 12-bit data into 8-bit data and transmits the latter to the data adjusting section 90 (#203).

At the data adjusting section 90, in addition to the color adjustment routinely carried for digital photographic print, a heat absorption rate compensating section 96 carries out a heat absorption rate compensating adjustment for a particular color in order to compensate for a difference in the heat absorption rate of a radiant heat beam dependent on the color of the ink. To this end, upon address assignment therefor from the adjustment mode selecting section 93 (#204), a heat absorption rate compensating adjustment table 96a is loaded to the heat absorption rate compensating section 96 (#205).

Specifically, among the principal ink colors used by this print head 2, a particular ink color which has relatively low absorptiveness to the radiant heat beam irradiated from an infrared heater of the heater device HU will be identified through experiment and the difference between absorptiveness of that color and those of the other colors will be stored as an adjustment coefficient within a heat absorption rate compensation adjustment table 96a. As an example of simple method for producing this heat absorption rate compensation adjustment table 96a, it is also proposed to obtain relative heat absorption coefficients of the respective color components by means of simulation from the spectrum data for the respective color components of the ink to be employed and the spectrum data of the radiant heat beam irradiated from the infrared heater 41 and calculate respective adjustment ratios and then provide them as an adjustment table.

For example, if yellow ink has lower absorptiveness than the inks of the other colors for the radiant heat beam from the infrared heater of the heater device HU, with a same heating period, only the yellow ink as applied to the recording medium 1 will not have been sublimed sufficiently. As a result, its sufficient fixation, that is, its color development in sufficient density will not be achieved, thus resulting in color irregularity in the finished print. In order to avoid such phenomenon, adjustment is effected for increasing in advance the density value of the yellow component in the color image data by an appropriate amount. Alternatively, adjustment may be made also by reducing the density values of the other color components while maintaining the density value of the yellow component same. In this case, however, it will be additional required to effect such measure as slightly increasing the heating period or slightly raising the heating temperature. However, as such measures can reduce the dynamic range of the color image data, it is preferred that such measure resulting in minimal reduction in the dynamic range be adopted.

Upon designation of this heat absorption rate compensation adjustment table 96a by the adjustment mode selecting section 93 and the subsequent loading of the table to the heat absorption rate compensating section 96 at the data adjusting section 90, this data adjusting section 90 now acts as the heat absorption rate compensating section 96. Needless to say, in case e.g. a conventional inkjet print paper not requiring any heating fixing process is employed as the recording medium 1, this heat absorption rate compensation adjustment can be omitted at all by using the adjustment mode selecting section 93 which can be operated by an operator via the keyboard 82 or the like.

Upon completion of all needed color image data adjustments at the data adjusting section 90, the resultant adjusted color image data is transmitted to the print data generating section 73 (#206). Incidentally, since the RGB color data have already been converted into the CMYK color image data at an appropriate stage after or before the other image processing at the data adjusting section 90, the color data transmitted to the print data generating section 73 are CMYK color image data.

Then, the print data generating section 73 effects a binarizing processing on the received 8-bit CMYK color image data to form gradation for the area gradation by the print head 2, thereby to generate binary CMYK print data and transmits this to the print controlling section 75 (#207).

The print controlling section 75 produces, from the received binary CMYK print data, driving pulse signals for the print head 2 and controls the driving elements of the print head 2 with these pulses for jetting ink droplets against the recording medium 1 (#208). At the same time, the head feeding controlling section 76 controllably drives the head feed mechanism 3 and the transport controlling mechanism 77 controllably drives the transportation mechanism, whereby a photographic image is gradually formed on the recording medium. The recording medium 1 having the photographic image formed thereon is caused to pass the heater device HU to be heated and fixed.

The data adjusting section 90 of the first controller 7 comprises the deformation compensating section 91 in the first embodiment and comprises the fixing color development characteristics compensating section 92 in the second embodiment and comprises the heat absorption rate compensating section 96 in the third embodiment, respectively. As a still further embodiment of the invention, these first through third embodiments may be combined with each other as desired or needed. Such combinations may be determined in accordance with the specification required for the image forming apparatus.

The invention may be embodied in any other manner as described above. Further changes or modifications will be apparent for those skilled in the art from the foregoing disclosure within the scope of the invention defined in the appended claims.

1. An image forming apparatus comprising:
a print head controllably driven according to print data;
a heater device for applying thermal energy to a recording medium in order to fix ink applied on its surface layer by the print head onto its fixing layer; and
a controller for producing the print data from image data;
wherein the controller includes a deformation compensating section for compensating for displacement between a target image and a fixed image due to size change in the vertical and/or lateral direction of the recording medium occurring in association with application of the thermal energy thereto.

2. The apparatus according to claim 1, wherein a recording medium identifying section is provided for identifying the type of the recording medium; and said deformation compensating section adjusts said image data with taking into consideration of a size change in that type of recording medium identified by the recording medium identifying section.

3. The apparatus according to claim 1, wherein said displacement between the target image and the fixed image is an image size difference.

4. The apparatus according to claim 1, wherein said deformation compensating section includes an adjustment table for compensating for displacement between the target image and the fixed image calculated based on a change in size in the recording medium in the vertical and/or lateral direction thereof due to application of the thermal energy thereto.

5. The apparatus according to claim 1, wherein test print data is provided for obtaining a change in size in the recording medium in the vertical and/or lateral direction thereof due to application of the thermal energy thereto.

6. An image forming apparatus comprising:
a print head controllably driven according to print data;
a heater device for applying thermal energy to a recording medium in order to fix ink applied on its surface layer by the print head onto its fixing layer; and
a controller for producing the print data from image data;
wherein the controller includes a fixing color development characteristics compensating section for effecting fixing color development characteristics compensation during the production of the print data from the image data, based on fixing color development characteristics of the ink to the fixing layer dependent on the thermal energy.

7. The apparatus according to claim 6, wherein a recording medium identifying section is provided for identifying the type of the recording medium; and said fixing color development characteristics compensating section adjusts said image data with taking into consideration of fixing color development characteristics of the recording medium whose type has been identified by the recording medium identifying section.

8. The apparatus according to claim 6, wherein an environment temperature detecting section is provided for detecting an environment temperature of said image forming apparatus; and said fixing color development characteristics compensating section adjusts said image data with taking into consideration of change in fixing color development characteristics occurring in correspondence to the environment temperature detected by said environment temperature detecting section.

9. An image forming apparatus comprising:
a print head controllably driven according to print data;
a heater device for applying thermal energy to a recording medium in order to fix ink applied on its surface layer by the print head onto its fixing layer; and
a controller for producing the print data from image data;
wherein the controller includes a heat absorption rate compensating section for compensating for a difference in a color-dependent heat absorption rate for a radiant heat beam during the production of the print data from the image data.

10. The apparatus according to claim 9, wherein said heat absorption rate compensating section includes a rewritable heat absorption rate compensation lookup table for storing therein adjustment coefficients calculated based on spectrum data for respective color components of the ink and spectrum data of the radiant heat beam.

11. An image forming apparatus comprising:
a print head controllably driven according to print data;
a heater device for applying thermal energy to a recording medium in order to fix ink applied on its surface layer by the print head onto its fixing layer; and
a controller for producing the print data from image data;
wherein said controller includes a deformation compensating section, a fixing color development characteristics compensating section and a heat absorption rate compensating section;
said deformation compensating section compensates for displacement between a target image and a fixed image due to size change in the vertical and/or lateral direction of the recording medium occurring in association with application of the thermal energy thereto;
said fixing color development characteristics compensating section effects fixing color development characteristics compensation during the production of the print data from the image data, based on fixing color development characteristics of the ink to the fixing layer dependent on the thermal energy; and
said heat absorption rate compensating section compensates for a difference in a color-dependent heat absorption rate for a radiant heat beam during the production of the print data from the image data.
